(19) United States
(12) Patent Application Publication
(10) Pub. No.: US 2012/0186846 A1
(43) Pub. Date: Jul. 26, 2012

(54) DATA COMMUNICATION CABLE

(76) Inventors: Thomas Haehner, Charleville Mezieres (FR); Tony Droguest, Revin (FR); Gilles Routa, Sedan (FR); Patrick Rofidal, Fumay (FR); Jean Francois Gallet, Signy-Le-Petit (FR)

(21) Appl. No.: 13/388,147

(22) PCT Filed: Aug. 12, 2010
(86) PCT No.: PCT/FR2010/051704

§ 371 Date: Apr. 10, 2012

(30) Foreign Application Priority Data
Aug. 19, 2009 (FR) 09 55706

(51) Int. Cl. H01B 11/06

(52) U.S. Cl. 174/34

(57) ABSTRACT

The subject of the invention is a data communications cable, characterized in that it comprises:
a plurality of groups (1,2,3,4) of four pairs of isolated conductors, the four pairs of isolated conductors being assembled in a helical fashion following a group assembly pitch, each pair being twisted in a helical fashion and surrounded by an electrical shield (9,10), the plurality of groups (1,2,3,4) being assembled in a helical fashion following a final assembly pitch,
an external sheath (8) surrounding the plurality of groups (1,2,3,4),
the final assembly pitch being variable along the cable.

The present invention relates to data communications cables comprising a plurality of groups of four pairs of individually isolated conductors allowing the transmission of data at a high rate.

An electrical cable generally comprises one or more sets of twisted conducting wires. A set is conventionally made up of two twisted conducting wires, which in this case is called a pair of conductors.

Cross-talk, far-end cross-talk or near-end cross-talk, denotes the electromagnetic interference between sets belonging to the same electrical cable. The exogenous cross-talk denotes the electromagnetic interference between sets belonging to different electrical cables. The phenomenon of cross-talk frequently poses a problem for the transmission of data.

In order to greatly reduce the cross-talk, a known solution is to twist the conducting wires together in a helical fashion, and preferably with a different pitch from one set to the other, and to surround each pair with an electrical shield in order to reduce the electromagnetic coupling. This arrangement notably allows high frequencies to be carried, in particular for applications going up to several tens of Gb/s.

In order to accommodate more pairs of conductors within the same space, and thus to make the external diameter of the cable as small as possible, it is advantageous so dispose the pairs of conductors in groups of four pairs of conductors.

If geometrical variations are periodically repeated within the cable, a problem that can arise is the appearance of reflection peaks of the signal, corresponding to a low reflection damping. These peaks occur at certain frequencies which are in correlation with the periodicity of the geometrical variation.

These peaks are undesirable, because they increase the noise and can lead to an increase in the linear loss along the cable, in other words the peaks reduce the signal/noise ratio and can reduce the data transmission rate.

A known solution is to shift the peaks toward higher frequencies by decreasing the pitch of the group assembly.

This solution however has the drawback that the assembly takes longer to fabricate, requires more conductors and labor and is more expensive.

The invention aims to overcome these drawbacks.

The subject of the invention is thus a data communications cable comprising:

a plurality of groups of our pairs of isolated conductors, the four pairs of isolated conductors being assembled in a helical fashion following a group assembly pitch, each pair being twisted in a helical fashion and surrounded by an electrical shield, the plurality of groups being assembled in a helical fashion following a final assembly pitch,

an external sheath surrounding the plurality of groups.

According to the invention, the final assembly pitch is variable along the cable.

This variation of the pitch of the final assembly allows the periodic variations in the geometry of the cable to be avoided and thus represents an inexpensive and productive alternative to the reduction in the group assembly pitch.

The cable does not need to comprise any other sheath aside from the external sheath. Thanks to the absence of sheaths surrounding each group, the cable is lighter, less bulky and comprises less inflammable material.

The group assembly pitch may also be variable along the cable.

In this case, the final assembly pitch and/or the group assembly pitch advantageously varies between two limiting values of the same sign.

The final assembly pitch and/or the group assembly pitch can vary according to a periodic function, for example a sinusoidal function.

The final assembly pitch and/or the group assembly pitch can also vary in a random fashion.

For a greater ease of assembly, the cable preferably comprises three, four or six groups.

According to a first embodiment, each group comprises one electrical shield per pair of isolated conductors.

According to a second embodiment, each group comprises a single electrical shield in the form of a cross.

The cross can separate the pairs of conductors from one another and surround each pair of conductors.

Other features and advantages of the present invention will become more clearly apparent upon reading the following description presented by way of illustrative and non-limiting example and with reference to the appended drawings in which:

FIG. 1 is a cross-sectional view of a cable of the prior art,

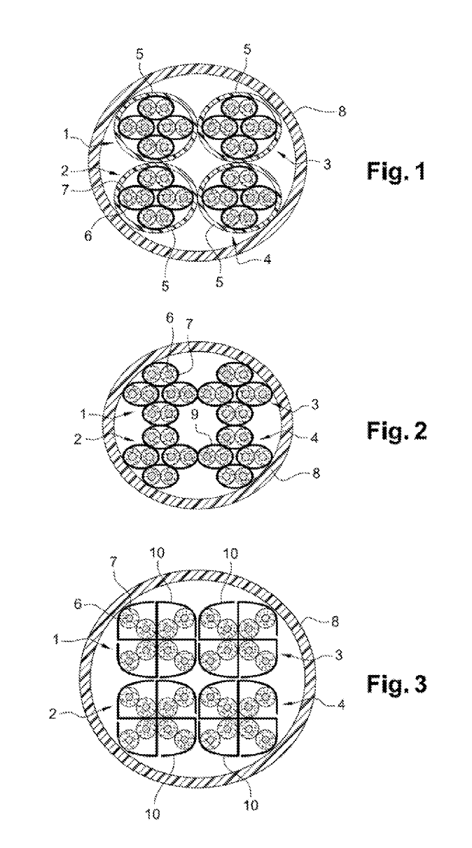

FIG. 2 is a cross-sectional view of a cable according to the invention, according to a first embodiment,

FIG. 3 is a cross-sectional view of a cable according to the invention, according to a second embodiment, and

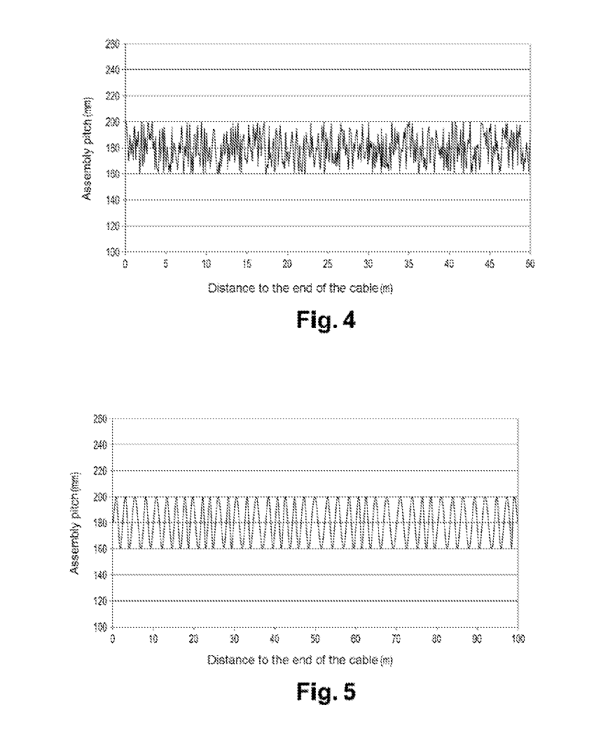

FIGS. 4 and 5 are two diagrams useful for the understanding of the invention.

A cable of the prior art is illustrated in FIG. 1. The cable, of circular cross-section, comprises four groups 1 to 4 of four pairs of isolated conductors, the pairs of which are individually shielded.

The conductors of the pairs are identical. Each conductor comprises a conducting core 6, typically made of copper, and a peripheral insulation 7. The two electrical conductors of each pair are directly assembled together in a helical fashion by twisting and thus exhibit a pitch referred to as pairing pitch.

Each group 1 to 4 of four pairs of isolated conductors is surrounded by a protection sheath 5, generally made of a polymer material. The assembly formed by the four groups 1 to 4 thus surrounded is itself surrounded by an external protection sheath 8.

Such a cable however has the drawback of being heavy, of having a large volume and of being composed of flammable materials.

The cable illustrated in FIGS. 2 and 3 has a circular cross-section. The elements identical to those in FIG. 1 carry the same references.

The cable illustrated in FIG. 2 differs from the cable of FIG. 1 in than it does not comprise any intermediate sheaths surrounding each group of four pairs of isolated conductors. In this embodiment, the cable thus comprises a single sheath 8, which is the external sheath forming the external part of the cable.

The absence of the intermediate sheaths advantageously allows the weight, the dimensions and the quantity of flammable material within the cable to be limited.

The pairing pitch of each pair of isolated conductors can be constant or otherwise along the cable.

Each group 1,2,3,4 can comprise a first pair having a first pairing pitch, a second pair having a second pairing pitch, a third pair having a third pairing pitch and a fourth pair having a fourth pairing pitch. Within the same group 1,2,3,4, the first pairing pitch, the second pairing pitch, the third pairing pitch and the fourth pairing pitch can be different, in such a manner as to reduce the cross-talk between the pairs.

The first pairing pitch can be identical within all the groups 1,2,3,4. Similarly, the second pairing pitch can be identical within all the groups 1,2,3,4, the third pairing pitch can be identical within all the groups 1,2,3,4, and the fourth pairing pitch can be identical within all the groups 1,2,3,4.

The groups 1 to 4 of four pairs of isolated conductors can be electrically shielded in two different ways. According to a first embodiment, such as illustrated in FIG. 2, a metal or metalized ribbon 9 is wound in a helical fashion around each pair of isolated conductors. Then, the four individually shielded pairs are assembled in a helical fashion to form a group. The pitch of the helix formed by the assembly of the our pairs of conductors is referred to as group assembly pitch. The final assembly of the four groups 1,2,3,4 is then carried out in a helical fashion. The pitch of the helix formed by the assembly of the four groups 1,2,3,4 of four pairs of conductors is referred to as final assembly pitch.

The group assembly pitch can be the same for all the groups 1,2,3,4 or may not be the same for all the groups 1,2,3,4.

For the connection of the cable, the individual shields of the pairs must he removed for the access to the conductors, a fact which makes the connection operation long and arduous.

In order to make the connection operation easier, and according to a second embodiment illustrated in FIG. 3, the electrical shields of the various pairs of each group 1,2,3,4 are formed by a central boss 10 in the form of a cross equipped with radial vanes separating the pairs from one another and surrounding each pair, in such a manner as to ensure that each of them are shielded. As for the first embodiment, a cable equipped with such a shielding exhibits a very low cross-talk, which makes it compatible with transmissions at high data rates. It is furthermore straightforward and quick to equip it with a connector terminal since, for the access to the conductors of the pairs, it just needs the cable to be stripped over a suitable length and the outer shielding to be removed over this length, then the boss 10 to be divided up, which represents a significant gain in time. The risks of damaging the conductors or of interfering with the disposition of the pairs are also largely avoided when the connector is installed.

If geometrical variations are periodically repeated within the cable, a problem that can occur is the appearance of reflection peaks of the signal, corresponding to a low reflection damping. These peaks appear at certain frequencies which are in correlation with the periodicity of the geometrical variation.

These peaks are undesirable because they increase the noise and can lead to an increase in the linear loss along the cable, in other words the peaks reduce the signal/noise ratio and can reduce the data transmission rate.

For an average pairing pitch of 50 mm and a group assembly pitch of 180 mm, a reflection peak of the signal for a frequency of the signal of around 650 MHz (and its multiples) and for a frequency of around 1300 MHz (and its multiples) is thus observed. The peak at 650 MHz is caused by the group assembly pitch, whereas the peak at 1300 MHz is caused by the pairing pitch.

Similarly, an increase in the linear damping for a frequency of the signal of around 650 MHz (and its multiples) and for a frequency of around 1300 MHz (and its multiples) is observed. The peak at 650 MHz is caused by the group assembly pitch, whereas the peak at 1300 MHz is caused by the pairing pitch.

A known solution is to shift the peaks toward higher frequencies by decreasing the group assembly pitch. It is thus observed that the peaks described hereinabove are observed at a frequency of 1.35 GHz (and its multiples) if the group assembly pitch is 85 mm instead of 180 mm.

This solution however has the drawback that the assembly is longer to implement, requires more conductor and labor and is more expensive.

In order to overcome this, and according to the invention, the final assembly pitch varies along the cable. This variation of the pitch of the final assembly allows the periodic variations in the geometry of the cable to be avoided and thus represents an inexpensive and productive alternative to the reduction in the assembly pitch.

Indeed, the final assembly pitch is ideally 600 mm but it creates a peak at 200 MHz (and its multiples) and interferes with the transmission of data, whereas the group assembly pitch can be fixed at 100 mm and creates a peak at around 1200 MHz, beyond the range of frequencies of the desired application. In this case, the final assembly pitch is varied while keeping the group assembly pitch constant.

It is furthermore possible to vary the pairing pitch along the cable, in addition to varying the group assembly pitch along the cable.

FIGS. 4 and 5 illustrates two embodiments of variation of the group assembly pitch along the cable.

According to a first embodiment, such as illustrated in FIG. 4, the group assembly pitch is in the range between two values, for example between 160 and 200 mm, and varies in a random fashion. The group assembly pitch is shown as a function of the distance to the end of the cable.

According to a second embodiment, such as illustrated in FIG. 5, the group assembly pitch is in the range between two limiting values, for example between 160 and 200 mm, and varies in a sinusoidal manner with a random period. The group assembly pitch is also shown as a function of the distance to the end of the cable.

Similarly, varying the final assembly pitch in a random fashion, or in a sinusoidal manner with a random period, may also be envisioned. The final assembly pitch and the group assembly pitch can each vary in a random fashion, or in a sinusoidal manner with a random period.

1. Data communications cable, comprising:
a plurality of groups of four pairs of isolated conductors, the four pairs of isolated conductors being assembled in a helical fashion following a group assembly pitch, each pair being twisted in a helical fashion and surrounded by an electrical shield, the plurality of groups being assembled in a helical fashion following a final assembly pitch,
an external sheath surrounding the plurality of groups, wherein
the final assembly pitch is variable along the cable.

2. Cable according to claim 1, wherein the cable does not comprise any other sheath apart from the external sheath.

3. Cable according to claim 1, wherein the group assembly pitch is variable along the cable.

4. Cable according to claim 3, wherein the final assembly pitch and/or the group assembly pitch varies between two limiting values of the same sign.

5. Cable according to claim 3, wherein the final assembly pitch and/or the group assembly pitch varies according to a periodic function.

6. Cable according to claim 3, wherein the final assembly pitch and/or the group assembly pitch in a random fashion.

7. Cable according to claim 1, wherein said cable comprises three, four or six groups.

8. Cable according to claim 1, wherein each group comprises one electrical shield per pair of isolated conductors.

9. Cable according to claim 1, wherein each group comprises a single electrical shield in the form of a cross.

10. Cable according to claim 9, wherein the cross separates the pairs of conductors from one another and surrounds each pair of conductors.
